(19) United States
(12) Patent Application Publication
(10) Pub. No.: US 2008/0213574 A1
(43) Pub. Date: Sep. 4, 2008

(54) Amphiphilic Fibers and Membranes and Processes for Preparing Them

(76) Inventors: Matthew G. McKee, Cincinnati, OH (US); John M. Layman, Blacksburg, VA (US); Matthew T. Hunley, Blacksburg, VA (US); Matthew P. Cashion, Christiansburg, VA (US); Timothy E. Long, Blacksburg, VA (US)

Correspondence Address: LATIMER, MAYBERRY & MATTHEWS IP LAW, LLP, 13873 PARK CENTER ROAD, SUITE 106, HERNDON, VA, 20171, US

(21) Appl. No.: 11/830,934

(22) Filed: Jul. 31, 2007

Related U.S. Application Data
(60) Provisional application No. 60/821,072, filed on Aug. 1, 2006.
(60) Provisional application No. 60/893,909, filed on Mar. 9, 2007.

(51) Int. Cl. B32B 7/02; H05B 6/00

(52) U.S. Cl. 428/332; 264/433

(57) ABSTRACT

The present invention relates to the fields of chemistry and biology and more particularly to the field of biomaterials. The present invention includes amphiphilic fibers and membranes, which can be used for biomembranes and biocompatible devices. The present invention also relates to processes for preparing amphiphilic fibers and membranes from solutions comprising amphiphilic molecules. More particularly, the present invention relates to processes for preparing fibers and membranes from electrospinning solutions comprising amphiphilic molecules. The present invention further provides fibers and nonwoven membranes comprising amphiphilic fibers chosen from anionic surfactants, cationic surfactants, nonionic surfactants, phospholipids, sulfobetaines, lyotropic liquid crystalline molecules, and/or block copolymers. Electrospun fibers offer the potential for direct fabrication of biologically based, high-surface-area membranes without the use of multiple synthetic steps, complicated electrospinning designs, or post-processing surface treatments. Polymeric phospholipids, for example, have been shown to be attractive candidates for blood purification membranes, artificial heart valves and organs, and other prosthetics, including other biocompatible devices.

### CROSS-REFERENCE TO RELATED APPLICATIONS

This application relies on the disclosure and claims the benefit of the filing date of U.S. Provisional Application No. 60/821,072, filed Aug. 1, 2006 and U.S. Provisional Application No. 60/893,909, filed Mar. 9, 2007, the entire disclosures of which are herein incorporated by reference.

### STATEMENT OF GOVERNMENT INTEREST

This invention was made partially with U.S. Government support from the U.S. Army Research Office under grant number DAAD19-02-1-0275. The U.S. Government has certain rights in the invention.

### BACKGROUND OF THE INVENTION

1. Field of the Invention

The present invention relates to the fields of chemistry and biology and more particularly to the field of biomaterials. The present invention includes amphiphilic fibers and membranes, which can be used for biomembranes and biocompatible devices.

2. Description of Related Art

Phospholipid-containing polymers are attractive candidates for blood purification membranes, artificial heart valves, artificial organs, and several other prosthetic devices. See, e.g., A. Koremtsu, Y. Takemoto, T. Nakaya, H. Inou, Biomaterials 23, 263 (2002); K. Kim, K. Shin, H. Kim, C. Kim, Y. Byun, Langmuir 20, 5396 (2004); S. H. Ye, J. Watanabe, Y. Iwasaki, K. Ishihara, Biomaterials 4143 (2003); and N. Morimoto, Y. Iwasaki, N. Nakabayahsi, K. Ishihara, Biomaterials 23, 4881 (2002). Significant work has focused on engineering stable biomembranes as a result of polymerizing functionalized phospholipids or post-polymerization functionalization with phospholipid reagents. J. H. Fendler, Science 223, 888 (1994); D. Chapman, Langmuir 9, 39 (1993).

Phospholipids possess a charged head group and a hydrocarbon tail that contain various amounts of unsaturation. Due to their amphiphilic chemical structure, phospholipids organize into a bilayer matrix, which serves as the building block of cell membranes. See C. W. Pratt, K. Cornely, Essential Biochemistry (John Wiley & Sons, Inc. 2004). Nakaya et al. synthesized an alkyl methacrylate monomer with a phospholipid head group, which suppressed protein adsorption and platelet adhesion. See S. Nakai, T. Nakaya, M. Imoto, Makromol. Chem. 79, 2349 (1978). Resistance to protein adsorption and/or platelet adhesion, for example, is a desirable characteristic of biocompatible devices, including biomembranes.

Existing techniques for designing biocompatible devices include coating suitable substrates with phospholipids. See H. K. Kim, K. Kim, Y. Byun, Biomaterials 26, 3444 (2005); and P. He, M. W. Urban, Biomacromolecules 6, 2455 (2005). Existing coating strategies, however, can have several disadvantages, including for example: (i) multiple synthetic steps for production of a phospholipid functionalized polymer are typically required and (ii) grafting to or grafting from methodologies are typically necessary to sufficiently tailor the surface properties.

The formation of fibers from aggregating small molecules is known. One example is the formation of cotton candy (crystallized sugar) from a sugar melt. In making cotton candy, sugar is melted, along with any food colorings, into a viscous liquid. The viscous liquid is then spun quickly, during which centrifugal forces push the liquid out of small holes. After being ejected from these holes, the sugar travels out radially through the air. During this flight, the sugar cools below its melting temperature and crystallizes into large fibers.

Another technique for preparing fibers is electrostatic spinning, otherwise referred to as electrospinning. Electrospinning is a polymer processing technique that forms fibers two to three orders of magnitude smaller than conventionally processed fibers. See D. H. Reneker, I. Chun, Nanotechnology 7, 216 (1996); and S. V. Fridrikh, J. H. Yu, M. P. Brenner, G. C. Rutledge, Phys. Rev. Lett. 90, 144502 (2003). Typically, electrospinning involves subjecting a charged solution or melt of a high molar mass polymer to an electric field. Chain entanglements in the charged fluid cause the fluid to resist breaking up into droplets and instead form a stable jet when the electrostatic repulsive forces on the fluid surface overcome the surface tension.

The range of fiber diameters for fibers generated by electrospinning techniques is roughly between 100 nm and 10 μm. See D. Li, Y. Xia, Adv. Mater. 16, 1151 (2004). The average fiber diameter of fibers processed by way of electrospinning is dependent on a number of variables: (i) process variables, such as electrical field strength, fluid flow rate, and working distance between the electrodes (See J. M. Deitzel, J. Kleinmeyer, D. Harris, N. C. Beck Tan, Polymer 42, 261 (2001)); (ii) solution variables, such as viscosity, electrical conductivity, surface tension, and solvent volatility (See K. H. Lee et al., J. Polym. Sci. Part B. Polym. Phys. 40, 2259 (2002)); and (iii) environmental variables, such as temperature, pressure, and humidity (See S. Megelski, J. S. Stephens, B. D. Chase, J. F. Rabolt, Macromolecules 35, 8456 (2002)); and C. L. Casper, J. S. Stephens, N. G. Tassi, B. D. Chase, J. F. Rabolt, Macromolecules 37, 573 (2004)).

Electrospinning studies typically involve high molar mass polymers. Polymer solutions or melts of high molar mass polymers are characterized by chain overlap and entanglements, which facilitate formation of electrospun fibers.

The inventors, however, recently correlated the electrospun fiber morphology and fiber diameter to the degree of chain entanglements and chain overlap in solution. See M. G. McKee, G. L. Wilkes, R. H. Colby, T. E. Long, Macromolecules 37, 1760 (2004); P. Gupta, C. Elkins, T. E. Long, G. L. Wilkes, Polymer 46, 4799 (2005). This empirical model was applicable to a range of polymer families, molar masses, and molecular architectures. Recently Wnek et al. developed a semi-empirical model that predicts the fiber morphology in terms of the polymer concentration, the weight average molar mass (M_{w}), and the entanglement molar mass (Mₑ). See S. L. Shenoy, D. W. Bates, H. L. Frisch, G. E. Wnek, Polymer 46, 3372 (2005).

The inventors' recent studies have demonstrated that high molar mass polymers are not essential for production of uniform electrospun fibers. Instead, the inventors have discovered that the presence of sufficient intermolecular interactions that effectively act as chain entanglements is the primary criterion. For example, polymers with strong quadruple hydrogen bonding capabilities displayed electrospinning behavior similar to unfunctionalized polymers of significantly higher molar mass. See M. G. McKee, C. L. Elkins, T. E. Long, Polymer 45, 8705 (2004).

Given that amphiphilic molecules can form entangled, worm-like micelles under appropriate solution conditions, the inventors have determined that amphiphiles can also be spun into fibers. The inventors have, thus, discovered in particular that the entangled worm-like micelles of phospholipids are capable of being electrospun. The large concentration of functional groups, as well as the molecular recognition and selectivity of biomolecules, provides ample possibilities for functional materials.

The formation of electrospun fibers from asolectin is the first example of using the electrospinning process to form fibers wholly composed of small molecules. As concentration of lecithin increased, the micellar morphology evolved from spherical to cylindrical, and at higher concentrations the cylindrical micelles overlapped and entangled in a fashion similar to polymers in semi-dilute or concentrated solutions. At concentrations above the onset of entanglements of the wormlike micelles, electrospun fibers were fabricated with diameters on the order of 1 to 5 micrometers. Electrospinning behavior of the small molecular amphiphilic molecules was shown to mirror that of high molar mass polymers.

The formation of fibers from small molecules provides a large step in the formation of biologically active surfaces and structures. Electrospun amphiphilic fibers offer the potential for direct fabrication of biologically based, high-surface-area membranes without the use of multiple synthetic steps, complicated electrospinning designs, or postprocessing surface treatments. Polymeric phospholipids, for example, are thus attractive candidates for blood purification membranes, artificial heart valves and organs, and other prosthetics.

### SUMMARY OF THE INVENTION

The present invention addresses at least some of the needs discussed above by providing fibers two to three orders of magnitude smaller than traditional melt or solution spinning techniques. The present invention additionally provides advantages over other traditional fiber processing techniques by providing electrospinning methods that reduce the requirement for multiple synthetic steps, such as grafting-to or grafting-from reactions, or phospholipid functionalization of monomers.

The present invention provides amphiphilic fibers and membranes, which can be used for biomembranes and biocompatible devices. The present invention also relates to processes for preparing amphiphilic fibers and membranes from solutions comprising amphiphilic molecules. More particularly, the present invention relates to processes for preparing fibers and membranes from electrospinning solutions comprising amphiphilic molecules. Further, the present invention provides fibers and nonwoven membranes comprising amphiphilic fibers formed from solutions comprising at least one of anionic surfactants, cationic surfactants, nonionic surfactants, phospholipids, sulfobetaines, lyotropic liquid crystalline molecules, and block copolymers. In the case of block copolymers, typically, suitable block copolymers have a number average molecular weight of less than about 10,000.

The inventors have recently found that amphiphilic molecules (amphiphiles) can be electrospun from wormlike micelle and liquid crystalline phases. In solution, the amphiphilic molecules (surfactants, block copolymers, phospholipids, etc.) organize into spherical micelles. As the concentration of amphiphile within solution increases, the micelles undergo one-dimensional growth into cylindrical wormlike micelles. These micelles behave as dynamic polymers, and their entangled solutions show viscoelastic behavior. Using this entangled solution structure, fibers can be generated for example by using electrostatic spinning or electrospinning, a polymer processing technique.

Features of the present invention include, for example, amphiphilic fibers and membranes, devices comprising such fibers and membranes, and processes for preparing them. The following summary of certain features of the invention provides for an introduction to the detailed description, which follows. This introductory explanation is provided merely as a convenience to highlight several aspects of the invention and does not limit the invention to the features discussed therein. Rather, the full scope of the invention should be understood as including all features discussed in the specification and appropriate modifications apparent to those of ordinary skill in the art.

The present invention provides nonwoven membranes comprising amphiphilic fibers having an average fiber diameter of less than about 100 μm. Such membranes, for example, comprise amphiphilic fibers having an average fiber diameter ranging from about 0.1 μm to about 10 μm. Even further, for example, the nonwoven membranes can comprise amphiphilic fibers having an average fiber diameter ranging from about 0.5 μm to about 10 μm, from about 1 μm to about 10 μm, from about 1 μm to about 5 μm, from about 100 nm to about 500 nm, from about 100 nm to about 1 μm, or from about 100 nm to about 2 μm.

The present invention further provides nonwoven membranes comprising amphiphilic fibers, wherein the fibers are chosen from anionic, cationic, and nonionic surfactants; phospholipids and sulfobetaines; lyotropic liquid crystalline molecules; and block copolymers having a number average molecular weight of less than about 10,000. The phrase “chosen from” in the context of this invention refers to the capability of having one or more of any of the choices identified. For example, nonwoven membranes comprising amphiphilic fibers chosen from phospholipids, surfactants, and block copolymers can comprise any one or more of those. The term “at least one” in the context of this invention refers to having one or more. For example, at least one amphiphilic fiber can refer to fibers comprising any one or more types of amphiphilic molecules. It is also understood within the context of this invention that the term amphiphilic fiber(s) refers to amphiphilic-type or amphiphilic-based fibers, which can comprise, be formed from, or be based on any one or more types of amphiphilic molecules.

Nonwoven membranes according to the invention also include nonwoven membranes comprising surfactant fibers, including phospholipid fibers.

Amphiphilic fibers according to the invention have an average fiber diameter of less than about 100 μm. Preferably, amphiphilic fibers according to the present invention have an average fiber diameter ranging from about 0.1 μm to about 10 μm. Even more preferably, the average fiber diameter of amphiphilic fibers according to the invention ranges from about 0.5 μm to about 10 μm, from about 1 μm to about 10 μm, from about 1 μm to about 5 μm, from about 100 nm to about 500 nm, from about 100 nm to about 1 μm, or from about 100 nm to about 2 μm.

The present invention further provides amphiphilic fibers and membranes prepared by electrospinning a solution of at least one amphiphilic molecule. Preferably, such electrospun amphiphilic fibers according to the invention comprise phospholipid fibers having an average fiber diameter of less than about 100 μm, for example, ranging from less than about 10 μm.

Prosthetics, including biocompatible devices, are also included within the scope of the invention, such as biocompatible devices comprising amphiphilic fibers having an average fiber diameter of less than about 100 μm. Such devices preferably comprise amphiphilic fibers with an average fiber diameter ranging from less than about 10 μm. Even further, biocompatible devices according to the invention can comprise amphiphilic fibers and/or nonwoven membranes as a coating.

Processes for preparing nonwoven membranes or amphiphilic fibers are also included within the scope of the invention, including processes comprising electrospinning a solution comprising at least one amphiphilic molecule. In embodiments, such amphiphilic molecules are chosen from anionic, cationic, and nonionic surfactants; phospholipids and sulfobetaines; lyotropic liquid crystalline molecules; and block copolymers having a number average molecular weight of less than about 10,000. Electrospinning can be performed by delivering a solution of at least one amphiphilic molecule at 6 mL/hr in a 15 kV electric field.

Fibers and membranes prepared by electrospinning in accordance with the present invention comprise an average fiber diameter of less than about 100 μm, for example, ranging from less than about 10 μm. Processes in accordance with the present invention are capable of producing amphiphilic fibers comprising phospholipids and having an average fiber diameter ranging from about 1 μm to about 5 μm, such as from about 2.8 μm to about 5.9 μm.

Solutions for preparing amphiphilic fibers and membranes in accordance with the present invention comprise at least one amphiphilic molecule. In embodiments, the solutions may comprise one or more types of amphiphilic molecules, including those chosen from anionic, cationic, and nonionic surfactants; phospholipids and sulfobetaines; lyotropic liquid crystalline molecules; and block copolymers. Solutions used in accordance with preparing amphiphilic fibers and membranes in accordance with the present invention include solutions comprising lecithin and/or n-hexadecyl trimethyl ammonium bromide (CTAB). Such solutions can comprise spherical or worm-like micelles of amphiphilic molecules in an amount above the entanglement concentration.

### BRIEF DESCRIPTION OF THE DRAWINGS

FIG. 1 represents the process by which worm-like micelles are formed from and become entangled in concentrated solutions of amphiphiles in polar solvent.

FIG. 2A represents the structure for phosphatidycholine (a primary component of lecithin), where R and R′ are fatty acid residues with different degrees of unsaturation.

FIG. 2B, much like FIG. 1 above, shows a schematic representation of lecithin transition from amphiphilic molecules to entangled, worm-like micelles.

FIG. 2C is a graph, showing the hydrodynamic radii (Rₕ) of lecithin in 70/30 CHCl₃/N,N′-dimethylformamide (DMF) solutions as a function of concentration.

FIG. 3 provides the concentration dependence of ηₛₚ for lecithin in 70/30 wt/wt CHCl₃/DMF with an entanglement concentration of 35 wt %.

FIGS. 4A-F provide field-emission scanning electron microscope (FESEM) images of electrospun fibers formed from various concentrations of lecithin in 70/30 wt/wt CHCl₃/DMF.

FIGS. 5A and 5B compare the dependence of phospholipid average fiber diameter on normalized concentration (η₀) with the electrospinning behavior of neutral, nonassociating polymers.

FIG. 6 shows the steady-shear rheology of CTAB in de-ionized water (DI H₂O).

FIG. 7 shows the specific viscosity plotted versus concentration of CTAB in de-ionized water and CTAB in a DI H₂O/methanol mixture (4:1 wt:wt H₂O/CH₃OH).

FIG. 8A shows an FESEM micrograph of CTAB fibers electrospun at 23 wt %.

FIG. 8B shows an FESEM micrograph of CTAB fibers electrospun at 25 wt %.

FIG. 9 shows specific viscosity versus concentration for solutions of CTAB in water and with 33 wt % added dextrose.

FIG. 10 provides dynamic light scattering (DLS) data from CTAB in water and sugar water at varying concentrations.

FIG. 11A provides FESEM images (at two magnifications) of CTAB fibers electrospun from dextrose solutions comprising 18 wt % CTAB.

FIG. 11B provides an FESEM image of CTAB fibers electrospun from dextrose solutions comprising 20 wt % CTAB.

FIG. 11C provides an FESEM image of CTAB fibers electrospun from dextrose solutions comprising 22 wt % CTAB.

FIG. 12 shows several polymerizable surfactants contemplated for in-situ polymerization during electrospinning.

FIG. 13 shows a schematic of exemplary electrospinning apparatus for in-situ polymerization by way of UV irradiation.

### DETAILED DESCRIPTION OF VARIOUS EMBODIMENTS OF THE INVENTION

Reference will now be made in detail to various exemplary embodiments of the invention. It is to be understood that the following detailed description is presented for the purpose of describing certain embodiments in detail. Thus, the following detailed description is not to be considered as limiting the invention to the embodiments described. Rather, the true scope of the invention is defined by the claims.

The present invention relates to amphiphilic fibers and membranes (also referred to as meshes or webs) and processes for preparing them. Generally, the amphiphilic fibers and membranes according to the invention can be prepared from solutions comprising at least one amphiphilic molecule (amphiphile). For example, one method of preparing the amphiphilic fibers and membranes according to the invention includes electrospinning solutions comprising at least one amphiphile.

Amphiphilic molecules in solution tend to aggregate based on hydrophobic and hydrophilic interactions. Amphiphiles that aggregate into rod-like or cylindrical aggregates (otherwise referred to as worm-like micelles) and have the potential to be electrospun include anionic, cationic, and nonionic surfactants; phospholipids and sulfobetaines; lyotropic liquid crystalline molecules; and block copolymers. Low molecular weight block copolymers, typically with a number average molecular weight of less than about 10,000, are suitable.

In the context of this invention, it is understood that the terms “molecule” and “amphiphile” can be used to refer to individual molecules or a collection or aggregation of molecules, including spherical micelles and/or cylindrical micelles. In other words, the term “molecule” or “amphiphile” may be used to describe one or a collection of more than one amphiphilic unit. The term “amphiphilic fiber(s)” refers to substantially cylindrical amphiphilic aggregates, which comprise, are based on, or otherwise formed from amphiphilic compounds, such as from solutions comprising amphiphilic molecules. “Nonwoven membranes” in accordance with the invention refers to fibers in an entangled or unwoven, for example, web-like or mesh-like form. Fibers of the nonwoven membranes according to the invention can be randomly oriented, layered, and/or aligned.

Amphiphilic aggregates can comprise spherical micelles with a hydrophilic shell and a hydrophobic core, or vice versa. For certain amphiphilic molecules in solution, for example surfactant solutions, as concentration of solute is increased, spherical micelles undergo one-dimensional growth into cylindrical aggregates. These aggregates are termed rod-like or worm-like micelles. Viscoelastic behavior of these entangled worms resembles that of entangled polymers. Some amphiphilic molecules, including surfactants, show a transition to liquid crystalline phases at even higher concentrations.

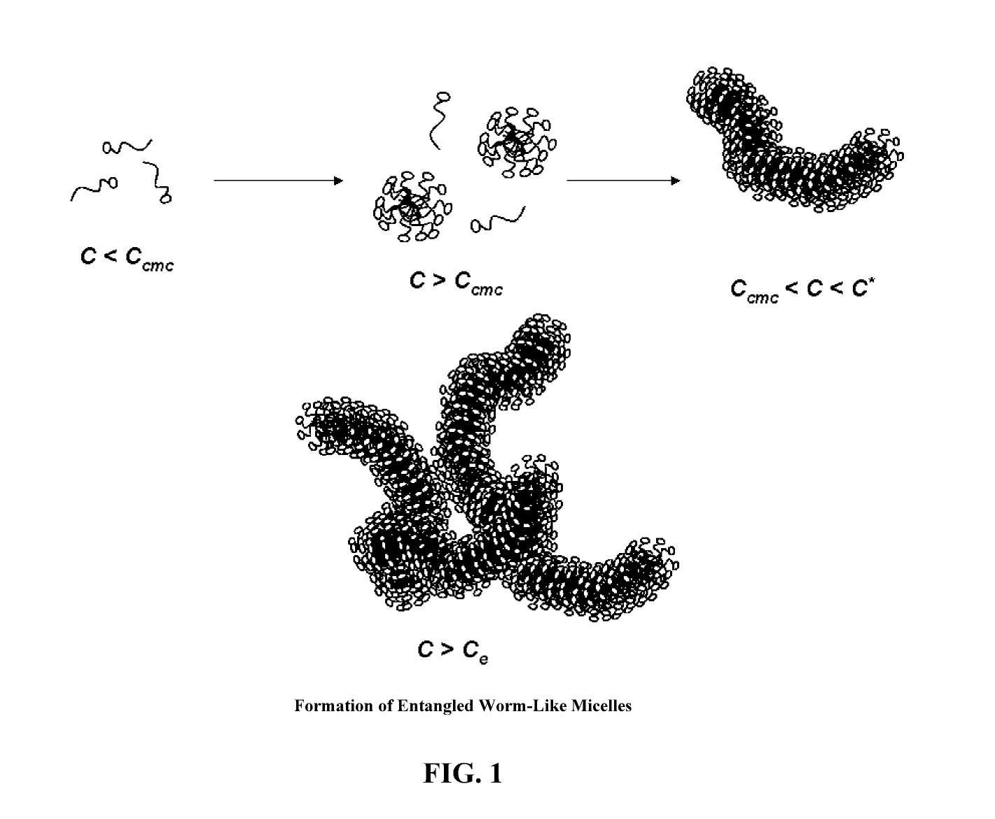

FIG. 1 shows, for example, the formation and entanglement of worm-like micelles from concentrated solutions of amphiphiles in polar solvent.

Electrospinning is a polymer processing technique to generate fibers from entangled solutions or melts. A droplet of polymer solution will elongate under a high electric potential (in the range 10-30 kV). If surface charge forces overcome surface density of the droplet, it will begin to jet towards a grounded target. During jetting, the solvent will evaporate, leading to reduction of jet diameter. Surface charges on the solution eventually reach a critical density, resulting in an instability during spinning. This instability is termed a bending instability, after which the polymer jet undergoes tremendous whipping and stretching in a conical shape as it continues to fly towards the target. The stretching and drawing of the process result in the formation of nano- or micron-scale fibers deposited as a nonwoven fibrous mat. Changes in target geometry can lead to the formation of aligned fibers. The electrospinning process according to the invention can generate fibers in a randomly oriented, nonwoven mesh, if desired.

Fiber diameters according to the invention are on the order of hundreds of nanometers to tens of microns, for example, from about 100 nm to about 100 μm. Further, for example, fibers according to the invention can have fiber diameters or average fiber diameters ranging from about 100 nm to about 10 μm, from about 500 nm to about 10 μm, or from about 1 μm to about 5 μm. Even further, for example, fibers according to the invention can have fiber diameters or average fiber diameters ranging from about 100 nm to about 500 nm, to about 1 μm, or to about 2 μm. As will be evident to those of skill in the art, as desired, the present invention can provide fibers and membranes having fiber diameters or average fiber diameters within the range of these exemplary numbers, and thus, each particular number need not be stated, though, each value is to be understood as having been specifically recited.

Generally, the thickness of an electrospinning mat, otherwise referred to as a nonwoven membrane, increases as electrospinning time increases. Likewise, thicknesses of the membranes typically can vary from dozens of micrometers to several millimeters. Unlike traditional woven fabrics, electrospun fabrics are typically composed of randomly-oriented fibers. The processing conditions can easily be tailored to create materials of varying thickness, porosity, membrane selectivity, and fiber orientation.

The following examples are provided to demonstrate preparation of fibers and membranes in accordance with the present invention. In particular, the following examples provide for the preparation of fibers and membranes from phospholipids and cationic surfactants. As exemplified, processes for preparing fibers and membranes in accordance with the invention include electrospinning techniques. In light of the examples provided, one of ordinary skill in the art would understand that any amphiphilic molecule, as well as any appropriate processing technique could be used.

### EXAMPLE 1

Lecithin, a natural mixture of phospholipids and neutral lipids, forms cylindrical or worm-like reverse micelles in nonaqueous solutions. See P. Schurtenberger, R. Scartazzini, L. J. Magid, M. E. Leser, P. L. Luisi, J. Phys. Chem. 94, 3695 (1990). As the concentration of lecithin is raised in solution, the micellar morphology changes from spherical to cylindrical, and at higher concentration the cylindrical micelles overlap and entangle in a similar way to that of polymer chains in semi-dilute or concentrated solution. See S. A. Mezzasalma, G. J. M. Koper, Y. A. Shchipnov, Langmuir 16, 10564 (1998). Water and other polar molecules serve to bridge the phosphate head groups between neighboring phospholipids through hydrogen bonds. See Y. A. Shchipunov, E. V. Shumilina, Mater. Sci Eng. C3, 43 (1995).

The morphology of lecithin micelles that formed in nonaqueous solutions was probed by using dynamic light scattering and solution rheology, and the concentration dependence of the zero shear viscosity (η₀) was compared to scaling relationships.

Moreover, because of entanglements between the worm-like micelles, the electrospinning behavior of the lecithin solutions was evaluated. The fabrication of a high surface area, potentially biocompatible, phospholipid membrane that involves a single processing step will offer exceptional promise for diverse biomedical applications.

In dilute nonpolar solutions, phospholipids form reverse spherical micelles with their polar head groups directed toward the hydrophilic core of the micelle. These spherical micelles undergo a one-dimensional, cylindrical growth with increased surfactant concentration.

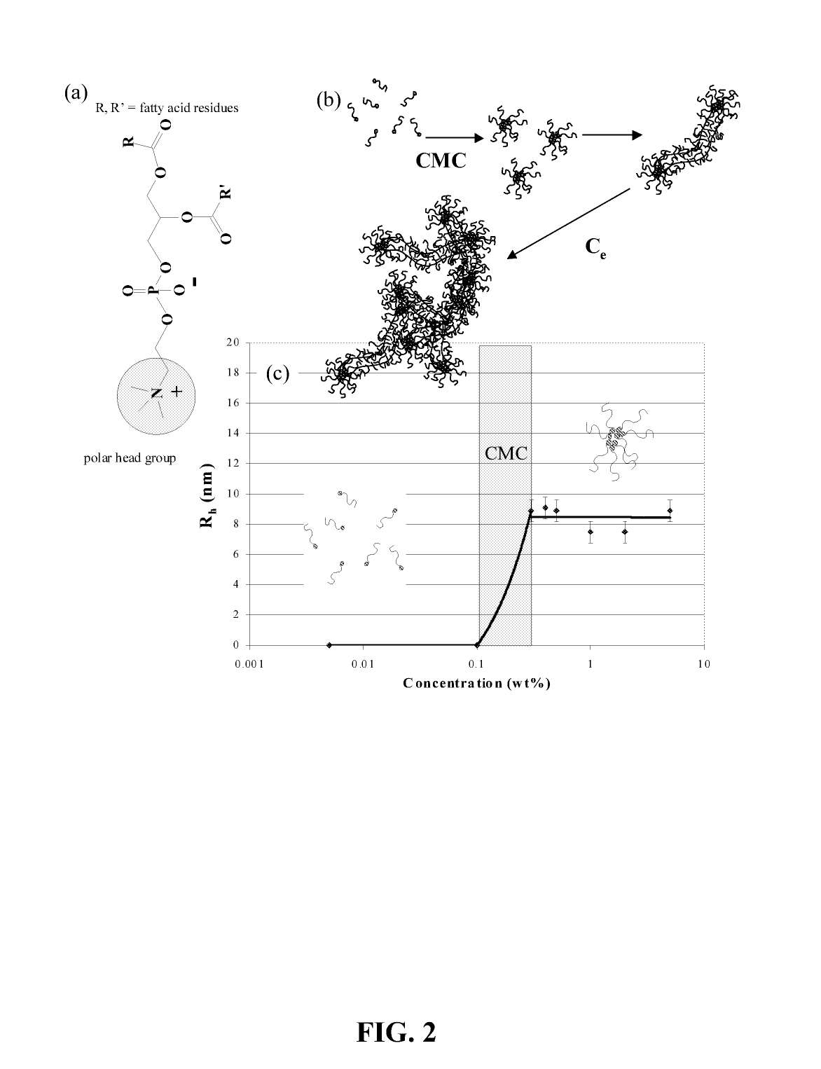

FIG. 2A, for reference, provides a structure for phosphatidycholine where R and R′ are fatty acid residues with different degrees of unsaturation. Phosphatidycholine is the primary constituent of some lecithin solutions, e.g., lecithin from soybean.

FIG. 2B shows a schematic representation of lecithin transition from amphiphilic molecules to entangled, worm-like micelles. FIG. 2B shows the typical micellar growth and entanglement of lecithin micelles, wherein at the critical micelle concentration (CMC), the lecithin amphiphiles rearrange to form spherical micelles. The micelles undergo cylindrical growth and entanglement couplings above the entanglement concentration (Cₑ).

FIG. 2C is a graph, showing the hydrodynamic radii (Rₕ) of lecithin in 70/30 CHCl₃/N,N′-dimethylformamide (DMF) solutions as a function of concentration. The average spherical micelle size was about 9 nm with a CMC (critical micelle concentration) of about 0.1 weight percent (wt %). This value is in good agreement with Rₕ values of lecithin micelles in cyclohexene as measured earlier by Kanamaru and Einaga. See M. Kanamaru, Y. Einaga, Polymer 3925 (2002). Moreover, within the concentration range investigated, the spherical micelles did not grow in size. Other researchers have also observed an independence of spherical lecithin micelles size with concentration. See P. A. Cirkel, G. J. M Koper. Langmuir 14, 7095 (1998).

Lecithin (obtained from soybean) was purchased from Fluka, and used as received. Lecithin was obtained as a mixture of phospholipids and neutral lipids, and the main component is phosphatidycholine (25%). The lecithin contained less than 3 mol % water, and was stored at −25° C. under argon atmosphere. The fatty acid residues of lecithin contain between 15 and 17 carbons. All other solvents and reagents were purchased from commercial sources and used without further purification.

Dynamic light scattering (DLS) studies were performed with an ALV-CGS3 goniometer (23 mW, 632.8 nm HeNe laser) at a 90° scattering angle and 25±0.1° C. Lecithin was dissolved in a cosolvent mixture 70/30 wt/wt chloroform/dimethyl formamide (CHCl₃/DMF) at concentrations between 0.01 wt % and 5 wt %. The intensity average hydrodynamic radius was measured. Steady shear experiments were performed with a VOR Bohlin strain-controlled solution rheometer at 25±0.2° C. using a concentric cylinder geometry. The bob and cup diameters employed for Theological measurements were 14 and 15.4 mm, respectively. The lecithin solutions were characterized by using a strain-controlled solution rheometer in the semi-dilute concentration regime.

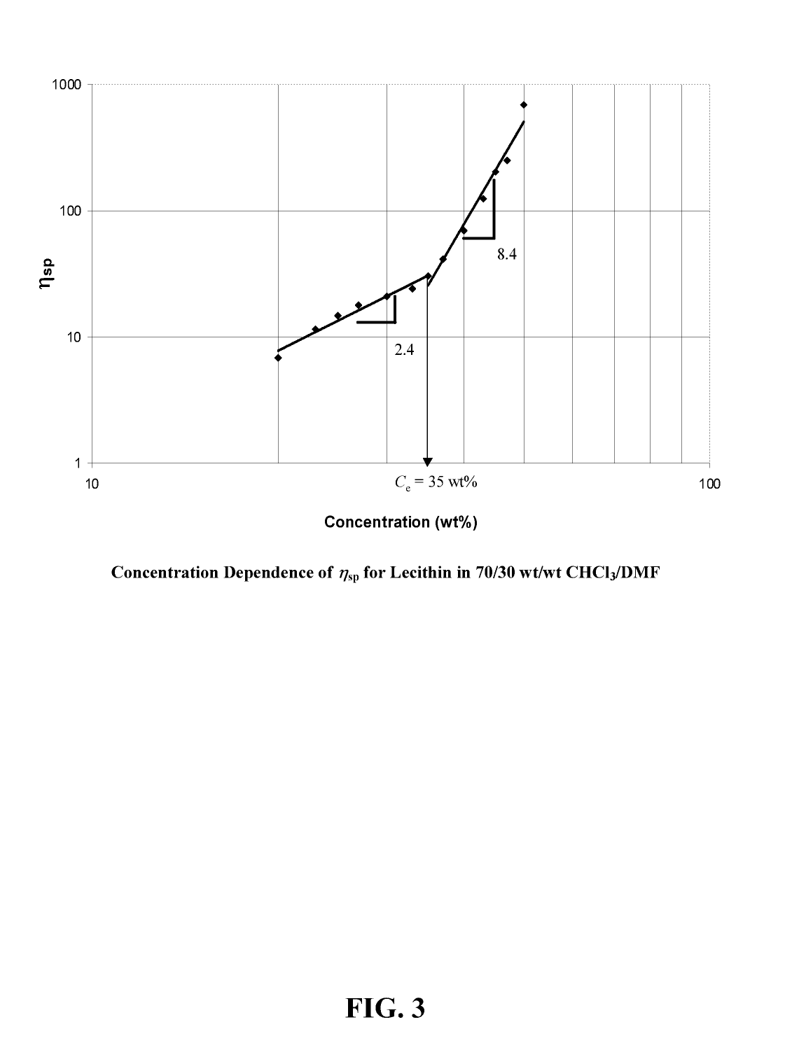

FIG. 3 shows the concentration dependence of the specific viscosity (ηₛₚ) for the lecithin solutions. In particular, FIG. 3 provides the concentration dependence of ηₛₚ for lecithin in 70/30 wt/wt CHCl3/DMF with an entanglement concentration of 35 wt %.

The ηₛₚ is defined as: ηₛₚ=(η₀−ηₛ)/ηₛ, where ηₛ is the solvent viscosity. The entanglement concentration (Cₑ) is 35 wt %, which separates the semi-dilute unentangled and the semi-dilute entangled regimes. In a similar fashion to polymer coils, the worm-like micelles form entanglement couplings above Cₑ. A significant difference between worm-like micelles and polymer chains is the former undergoes chain scission and thus does not possess a constant “chain length” or contour length. See M. E. Cates, Macromolecules 20, 2289 (1987). The slopes in the semi-dilute unentangled and semi-dilute entangled regimes were 2.4 and 8.4, respectively, which were significantly larger than those predicted for neutral polymers in a good solvent ηₛₚ˜C^{1.25} and ηₛₚ˜C^{3.75} in unentangled and entangled regimes, respectively). See R. H. Colby, M. Rubinstein, Macromolecules 23, 2753 (1990). This strong concentration dependence is similar to the behavior displayed by associating polymers. See R. J. English, H. S. Gulati, R. D. Jenkins, S. A. Khan, J. Rheol. 41, 427 (1997). The concentration dependence of ηₛₚ was also greater than predictions from the reversible chain scission model (ηₛₚ˜C^{5.25}).

Solution rheological studies of micellar solutions performed by other researchers also displayed exponents larger than 5.25. See L. J. Magid, J. Phys. Chem. B 102, 4064 (1998). In particular, Cappelaere et al. observed a power-law exponent of about 12 for cetyltrimethylammonium bromide aqueous solutions. See E. Cappelaere, R. Cressely, J. P. Decruppe, Colloids and Surf. A. Physiochem. Eng. Aspects 104, 353 (1995). The unusually large concentration dependence suggests the presence of intermolecular associations between the worm-like micelles. See M. Rubinstein, A. N. Semenov, Macromolecules 34, 1058 (2001). Polymer chains that are modified with associating functional groups also display a very strong η₀ dependence on concentration because of the increased probability of intermolecular associations compared with intramolecular association with increasing concentration. See E. J. Regalado, J. Selb, F. Candau, Macromolecules 32, 8580 (1999); and G. McKee, C. L. Elkins, T. Park, T. E. Long, Macromolecules 38, 6015 (2005).

The inventors have previously described the onset of chain entanglements as a criterion for the formation of electrospun fibers. Generally, uniform fibers formed at 2 to 2.5Cₑ due to stabilization of the electrified jet and suppression of the Raleigh instability from the entanglement couplings. It should be noted that electrospun fiber formation would not be possible if the phospholipids did not form a supramolecular entangled network, because individual phospholipids are low molar mass compounds that are incapable of forming entanglements.

Lecithin was dissolved in 70/30 wt/wt CHCl₃/DMF at various polymer concentrations. The solutions were then placed in a 20 mL syringe, which was mounted in a syringe pump (KD Scientific Inc, New Hope, Pa.). The positive lead of a high voltage power supply (Spellman CZE1000R; Spellman High Voltage Electronics Corporation) was connected to the 18-gauge syringe needle by way of an alligator clip. A grounded metal target (304-stainless steel mesh screen) was placed 10 cm from the needle tip. The syringe pump delivered the polymer solution at a controlled flow rate of 6 mL/h, and the voltage was maintained at 15 kV.

All lecithin solutions were electrospun at constant conditions, 15 kV, 6 ml/hour syringe flow rate, and 10-cm working distance, from the semi-dilute unentangled and the semi-dilute entangled regimes. The solution rheological experiments and electrospinning trials were performed at the same conditions (room temperature and 70/30 wt/wt CHCl₃/DMF) to ensure constant hydrodynamic dimensions of the worm-like micelles in solution before experiencing the electric field.

Electrospun fiber diameter and morphology were analyzed using a Leo® 1550 field emission scanning electron microscope (FESEM). Fibers for FESEM analysis were collected on a ¼″×¼″ stainless steel mesh, mounted on a SEM disc, and sputter-coated with an 8 nm Pt/Au layer to reduce electron charging effects. Fifty measurements on random fibers for each electrospinning condition were preformed and average fiber diameters reported.

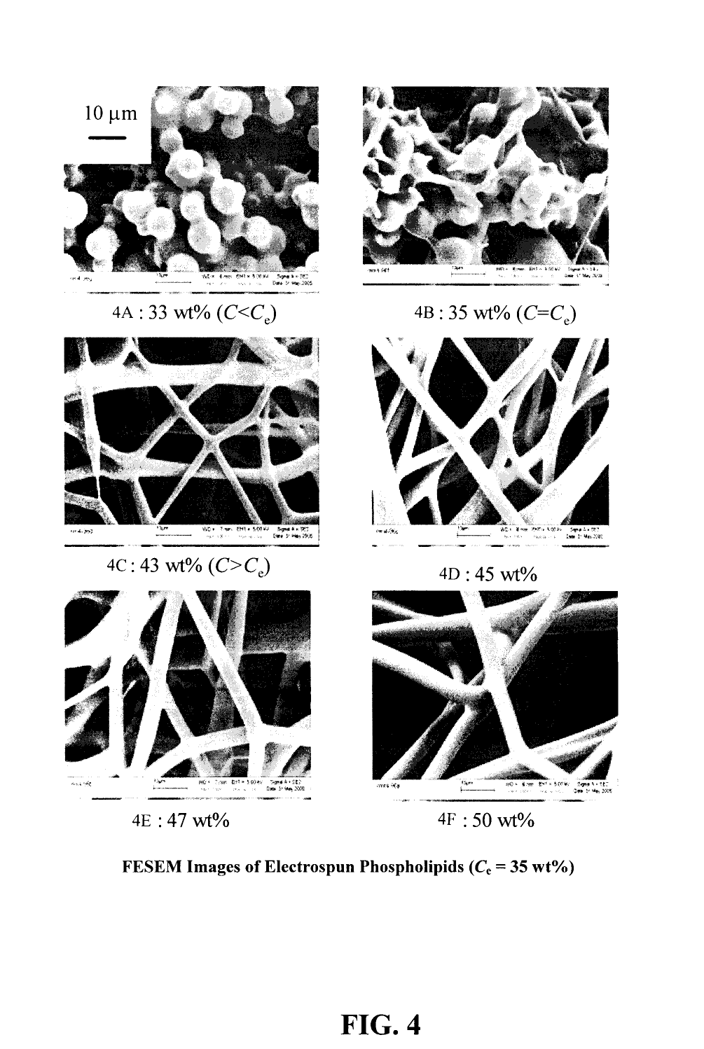

FIGS. 4A-F provide field-emission scanning electron microscope (FESEM) images of electrospun fibers that were formed from various concentrations of lecithin in 70/30 wt/wt CHCl₃/DMF (e.g., 33 wt %, 35 wt %, 43 wt %, 45 wt %, 47 wt %, and 50 wt %), with an entanglement concentration (Cₑ) of 35 wt %.

More specifically, as shown in FIG. 4A, with a lecithin concentration of 33 wt %, wherein C<Cₑ (i.e., the lecithin concentration (33 wt %) is less than the entanglement concentration (35 wt %), droplets were formed. Droplets form under such circumstances due to the absence of chain entanglements in the supramolecular structure, which resulted in destabilization of the electrified jet.

As shown in FIG. 4B, as the concentration was raised to 35 wt % and the concentration was thus equal to the entanglement concentration (i.e., (C=Cₑ)), droplets still dominated the morphology, although there is evidence of a low concentration of fibers between the droplets.

As shown in FIG. 4C, electrospun fibers with an average diameter of 2.8 μm were formed at a concentration of 43 wt % (C>Cₑ). Fibers were formed for C>Cₑ because the entanglements between the worm-like micelles stabilized the electrospinning jet and prevented breakup of the jet.

The transition from beaded fibers to fibers with elongated beads can be seen by comparing FIGS. 4A, 4B, and 4C. This phenomenon was also observed for several different polymer families. See H. Fong, D. H. Reneker, Polymer 40, 4585 (1999); and K. H. Lee, H. Y. Kim, H. Y. Bang, Y. H. Jung, S. G. Lee, Polymer 44, 4029 (2003).

As shown in FIG. 4D, uniform, electrospun fibers with an average fiber diameter of 3.3 μm were formed when lecithin was electrospun from a concentration of 45 wt %.

As shown in FIGS. 4E and 4F, average fiber diameter increased from 4.2 μm to 5.9 μm when the lecithin concentration was raised from 47 wt % to 50 wt %, respectively.

Energy dispersive spectroscopy (EDS) indicated that the lecithin amphiphiles were randomly oriented within the electrospun fibers without preferential layering. Moreover, ¹H nuclear magnetic resonance (NMR) spectroscopy confirmed that the chemical composition of the electrospun fibers and lecithin precursor were identical, which suggested that the electrospinning process did not significantly alter the chemical structure of the phospholipid.

On the basis of the normalized polymer concentration (C/Cₑ), the average electrospun fiber diameter (D) was accurately predicted for various polymer families, molar mass, and chain topology according to the equation, D[μm]=0.18(C/Cₑ)^{2.7}. The empirical correlation under predicted the fiber diameter for poly(alkyl methacrylates) with quadruple hydrogen bonding capabilities because of the strong concentration dependence of the solution viscosity.

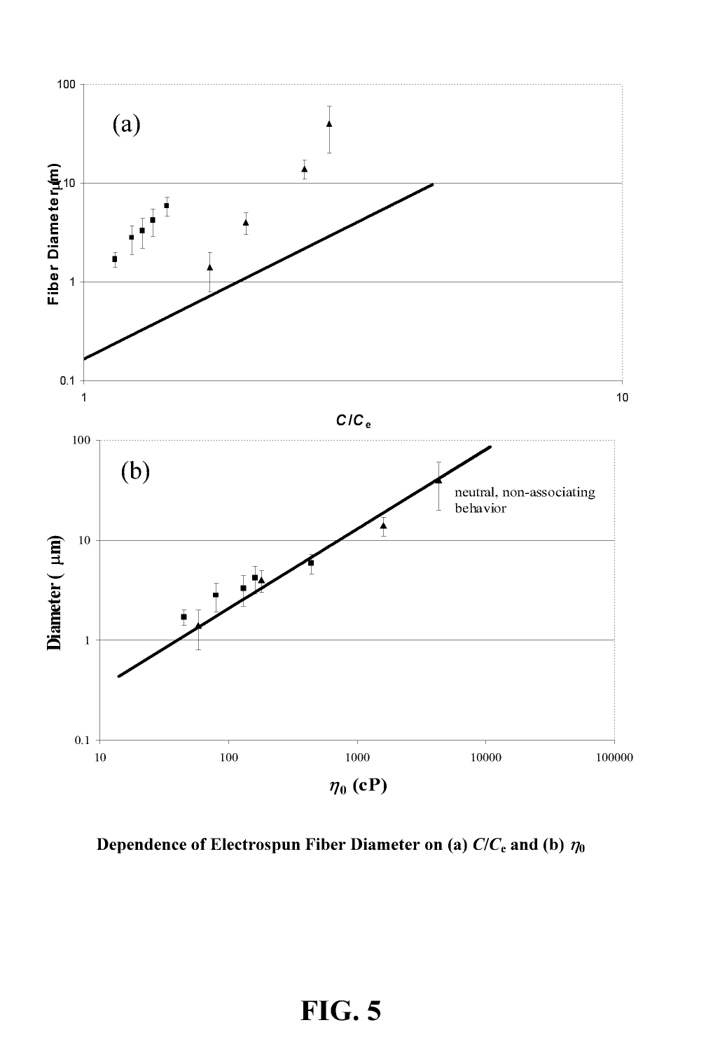

FIGS. 5A and 5B compare the dependence of the phospholipid fiber diameter on normalized concentration with the electrospinning behavior of neutral, nonassociating polymers (black line). In addition, the fiber diameter dependence for poly(alkyl methacrylates) with pendant quadruple hydrogen bonding groups is included. Because of the associations that are formed between hydrogen bonding groups, the fiber diameter was significantly larger than predicted. On inspection of FIG. 5A, it is apparent that that the lecithin electrospinning behavior was similar to associating polymers, which is consistent with the presence of intermolecular associations between the lecithin micelles.

FIG. 5B shows the dependence of the average fiber diameter on η₀ for the micellar solution. The electrospinning behavior was also compared to the previous correlations developed for neutral, nonassociating polymers (black line). FIG. 5B indicates excellent agreement between the phospholipid fiber diameter and the neutral polymer fiber diameter at a given value of η₀. Thus, the large deviation from the fiber diameter−C/Cₑ relationship was due to the strong concentration dependence of η₀ for the entangled lecithin micelles solutions. This observation was also similar to the electrospinning behavior of associating polymers as discussed earlier.

### EXAMPLE 2

Nonwoven mats of electrospun fibers are characterized by their high porosities and well-defined pore sizes. Exemplary fiber diameters and pore sizes are provided in Table 1 for fibers prepared from phospholipid solutions, e.g., 43 and 45 wt % asolectin.

TABLE 1
43 wt % Asolectin
Fiber Diameters (μm) (avg = 2.7, std dev = 1.4)

| | | | | |
|---|---|---|---|---|
| 1.4 | 4.1 | 6.2 | 3.1 | 2.7 |
| 3.0 | 2.9 | 2.8 | 2.9 | 0.53 |
| 1.2 | 2.0 | 2.4 | | |

Pore Diameters* (μm) (avg = 14.9, std dev = 3.8)

| | | | | |
|---|---|---|---|---|
| 21.3 | 14.0 | 16.8 | 11.2 | 11.4 |

45 wt % Asolectin
Fiber Diameters (μm) (avg = 4.8, std dev = 1.7)

| | | | | |
|---|---|---|---|---|
| 9.4 | 6.3 | 5.3 | 5.0 | 3.9 |
| 2.9 | 2.6 | 5.4 | 4.8 | 4.4 |
| 3.9 | 3.1 | 4.9 | | |

Pore Diameters* (μm) (avg = 18.5, std dev = 4.2)

| | | | | |
|---|---|---|---|---|
| 11.6 | 23.6 | 17.4 | 18.1 | 21.9 |

*Pore diameters calculated as average cross-sectional distance between fibers.

### EXAMPLE 3

Fibers can be generated from solutions of low molar mass surfactants, such as n-hexadecyl trimethyl ammonium bromide (CTAB), in de-ionized water as well as in 80/20 wt %/wt % deionized water/methanol. The addition of sugar, for example, dextrose, can affect overall solution viscosity while not affecting the one-dimensional micellar structure of the surfactants.

Hexadecyltrimethylammonium bromide (CTAB), a cationic surfactant, can be used to generate fibers and membranes according to the invention. Cationic surfactants are capable of forming worm-like micelles in solution. The amphiphile CTAB, for example, has been shown previously to aggregate into worm-like micelles with viscoelastic properties.

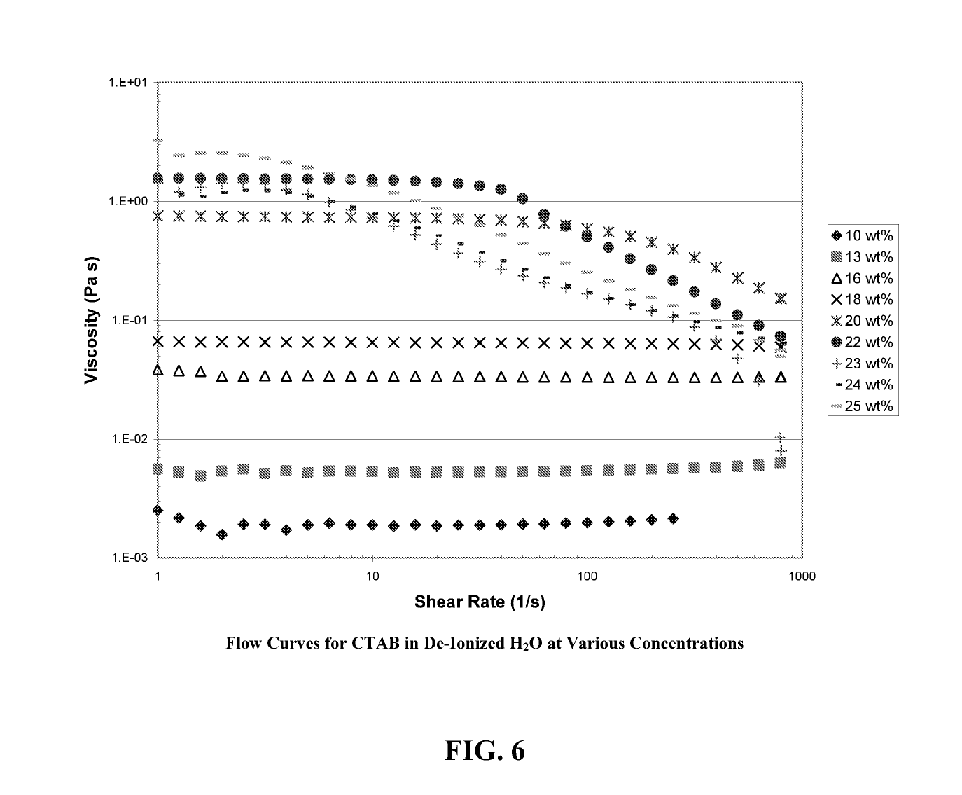

FIG. 6 shows the steady-shear rheology of CTAB in de-ionized water (DI H₂O). FIG. 6 shows Newtonian behavior at lower concentrations and shear-thinning behavior at higher concentrations and shear rates, a behavior analogous to that of polymer solutions.

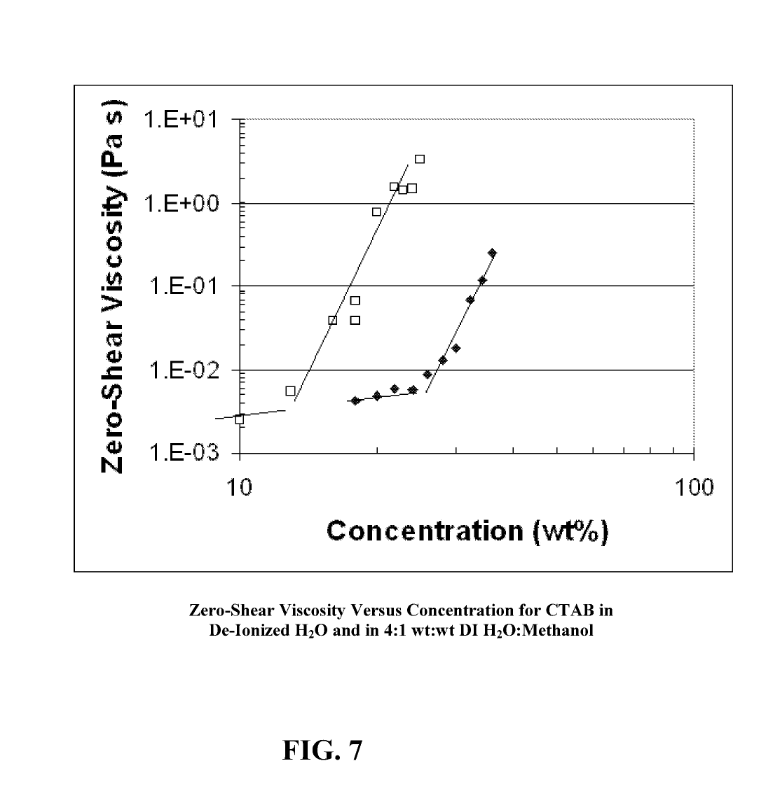

FIG. 7 shows the specific viscosity plotted versus concentration of CTAB in de-ionized water (DI H₂O) (shown as open squares) and in a DI H₂O/methanol mixture (4:1 wt:wt H₂O/CH₃OH) (shown as diamonds). CTAB electrospun from water at concentrations above 20 wt %. From the water/methanol mixture, CTAB electrospun at concentrations above 22 wt %. The critical concentration for entanglements is visible where scaling changes. Two regimes of different viscosity scaling are seen, with slopes of 1.1 and 10. Above and below Cₑ, viscosity scales with concentration to the 1.1 and 10 power, respectively, for both solvents. These are identified as the semi-dilute unentangled and semi-dilute entangled regimes, also mirroring polymer solutions. For neutral, non-associating polymers in good solvent, viscosity has been shown to scale with concentration to the 1.25 and 4.7 powers in the semi-dilute unentangled and semi-dilute entangled regimes, respectively. In the entangled regime, the large increase in scaling factor has been attributed to the associative behavior of CTAB. A critical concentration for entanglements, Cₑ, was identified at 11 and 23 wt % surfactant for pure water and water/methanol mixture, respectively.

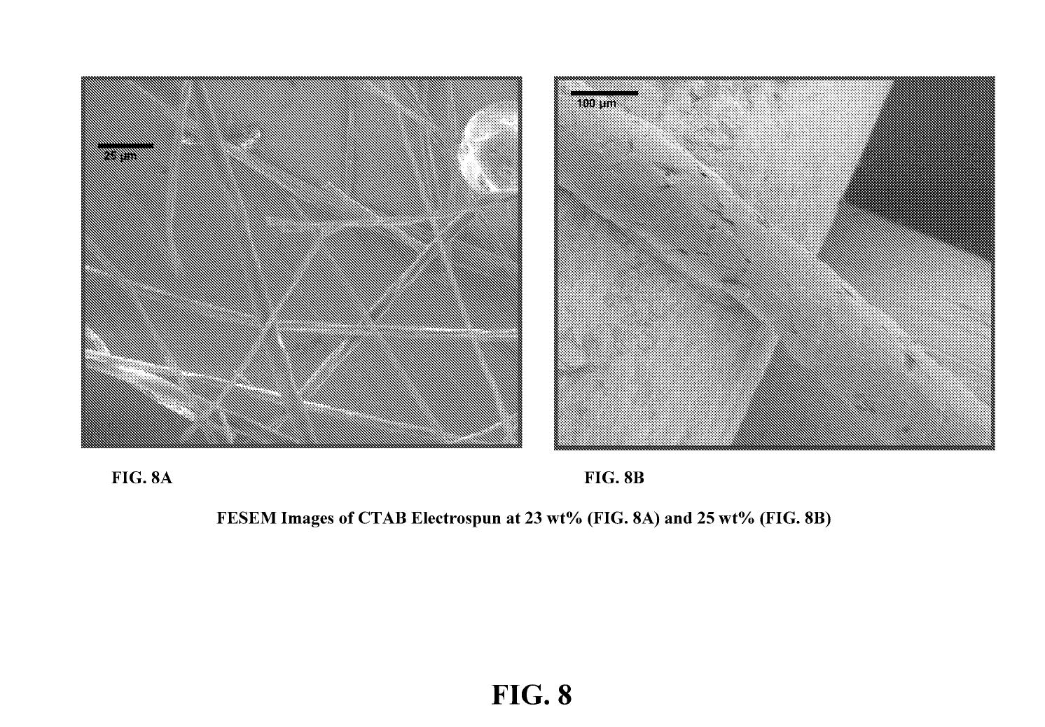

FIGS. 8A and 8B show field-emission scanning electron microscope (FESEM) micrographs of the surfactant fibers electrospun at varying concentrations: (A) 23 wt % CTAB from an entangled wormlike micellar solution and (B) 25 wt % CTAB from a nematic liquid crystalline solution. Above 25 wt %, CTAB undergoes a transition to a nematic liquid crystalline phase. As seen in FIG. 8B, electrospun fibers from the nematic phase are thicker than fibers generated from an isotropic phase by over an order of magnitude (˜5 versus 120 μm, respectively).

Amphiphile, solvent, and a magnetic stir bar were added to a glass scintillation vial, which was then sealed with paraffin film. The solutions were allowed to stir with gentle heat for 72 hours. Electrospinning was performed at ambient temperature and humidity. In a sample electrospinning experiment, sample was added to a 20-mL syringe equipped with an 18-gauge stainless steel needle. The syringe was placed in a syringe pump (KD Scientific) and solution metered at 5 mL/h. A high voltage power supply (Spellman CZE-1000R) was attached to the syringe needle with an alligator clip, and a stainless steel mesh was grounded and placed 15 cm from the tip of the needle. The potential on the solution was increased to 25 kV, and solution began to accelerate toward the grounded target, depositing in a non-woven fibrous mat. Fibers were imaged on a LEO 1550 field-emission scanning electron microscope (FESEM) at 5 kV accelerating voltage.

The addition of dextrose to water/alcohol solution has been shown to increase overall viscosity without significantly influencing amphiphilic superstructure.

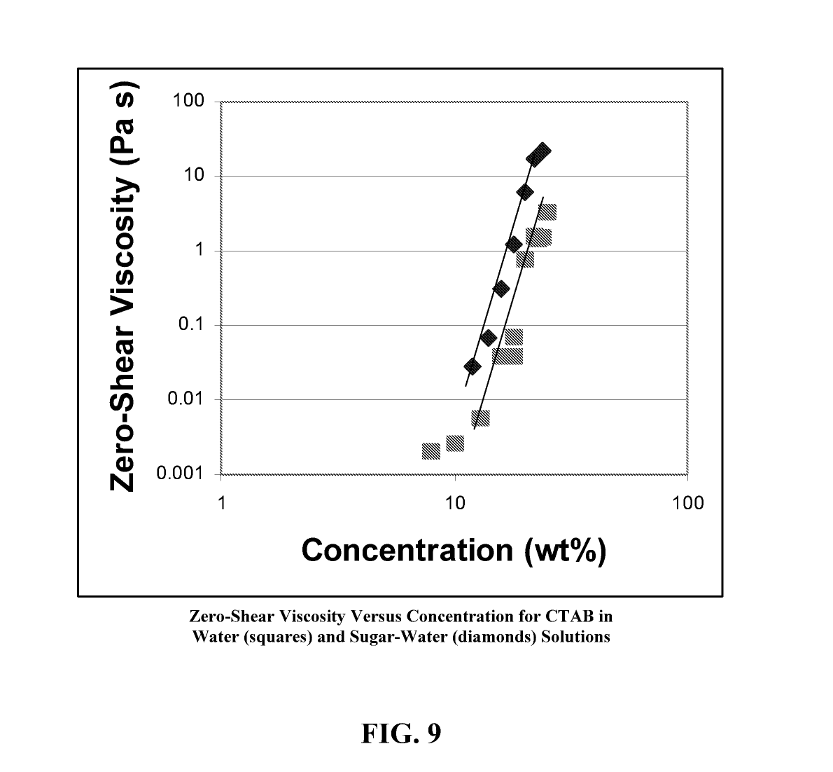

FIG. 9 shows specific viscosity versus concentration for CTAB in water (shown as squares in the graph) with 33 wt % added dextrose (shown as diamonds). For the sugar solutions and in pure water solutions, viscosity scales similarly with concentration. Scaling factors for viscosity are 10 for both solutions in the semi-dilute entangled regime, although viscosities for the sugar solutions are one order of magnitude higher.

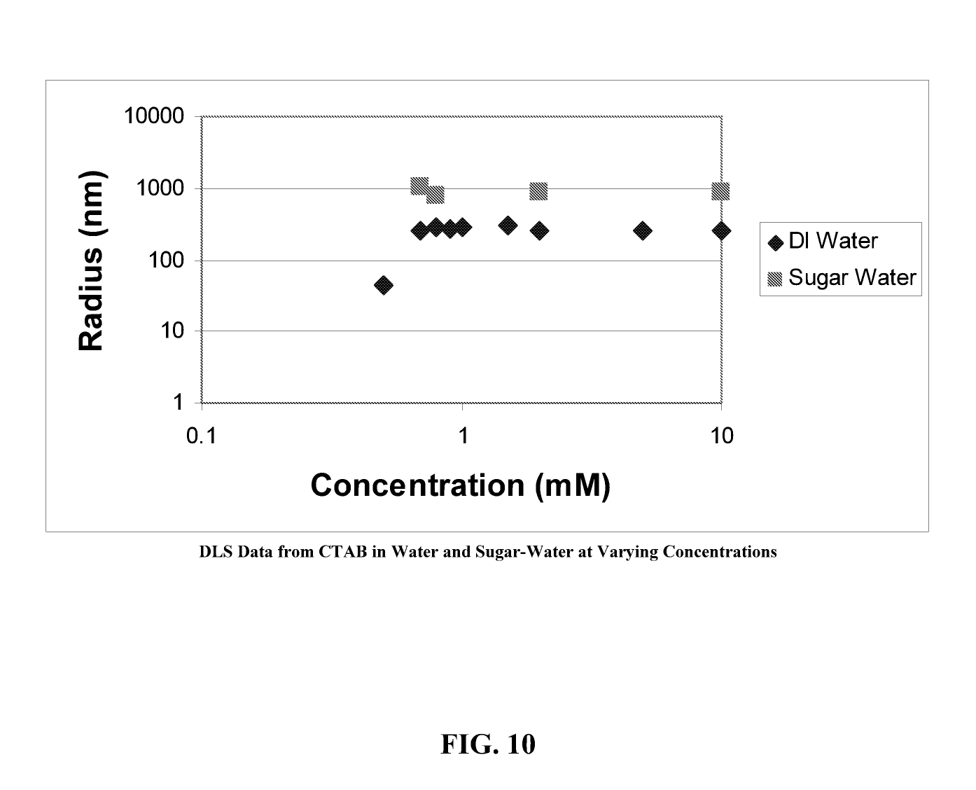

FIG. 10 provides dynamic light scattering (DLS) data from CTAB in water and sugar water at varying concentrations. As shown in FIG. 10, dynamic light scattering experiments indicate slightly larger aggregates. The amphiphiles in sugar solution electrospun from a lower overall CTAB concentration, due to the increased viscosity.

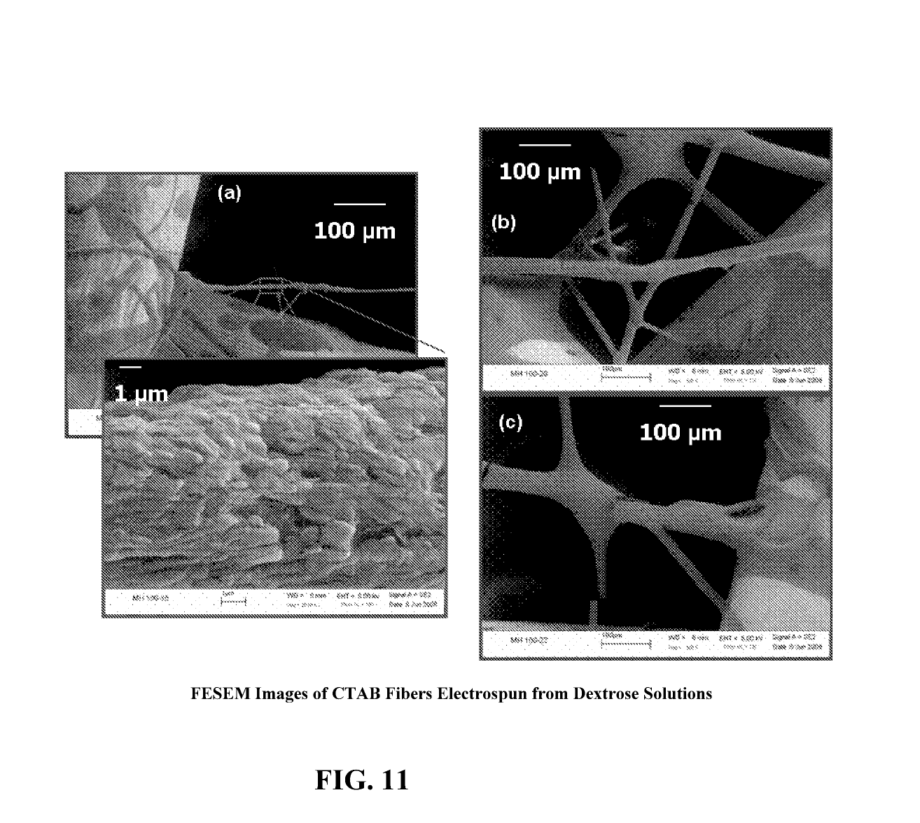

FIGS. 11A-C provide FESEM images of CTAB fibers electrospun from dextrose solutions. As shown in FIGS. 11A-C, the surface morphology of the sugar/CTAB fibers is much rougher than the pure CTAB fibers. All fibers exhibited the same surface morphology. In particular, FIG. 11A shows (at two magnifications) fibers electrospun from 18 wt % CTAB in solution, FIG. 11B shows fibers electrospun from 20 wt % CTAB in solution, and FIG. 11C shows fibers electrospun from 22 wt % CTAB in solution.

The sugar/CTAB solutions are prepared by dissolving the CTAB in the appropriate amount of pre-mixed sugar/de-ionized H₂O solvent. The solutions were allowed to equilibrate as described above. Dextrose was used in these experiments, although maltose and sucrose can also be used. See Fischer, P; Rehage, H, Langmuir 1997, 13, 7012-7020. The same electrospinning equipment and experimental parameters were used as were previously described for electrospinning of CTAB in water without the addition of sugar to the solution.

### EXAMPLE 4

To increase the durability of the electrospun fibers, polymerizable surfactants can be synthesized. Methacrylate or acetylene groups in the surfactant tail allow surfactant molecules to be polymerized without significantly altering their solution structure.

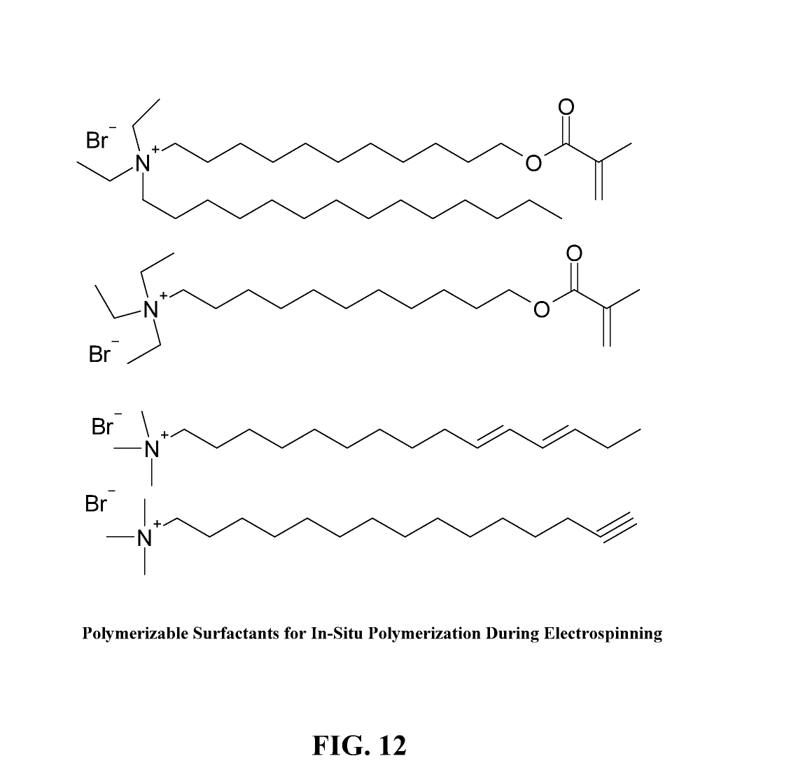

FIG. 12 shows several polymerizable surfactants contemplated for in-situ polymerization during electrospinning.

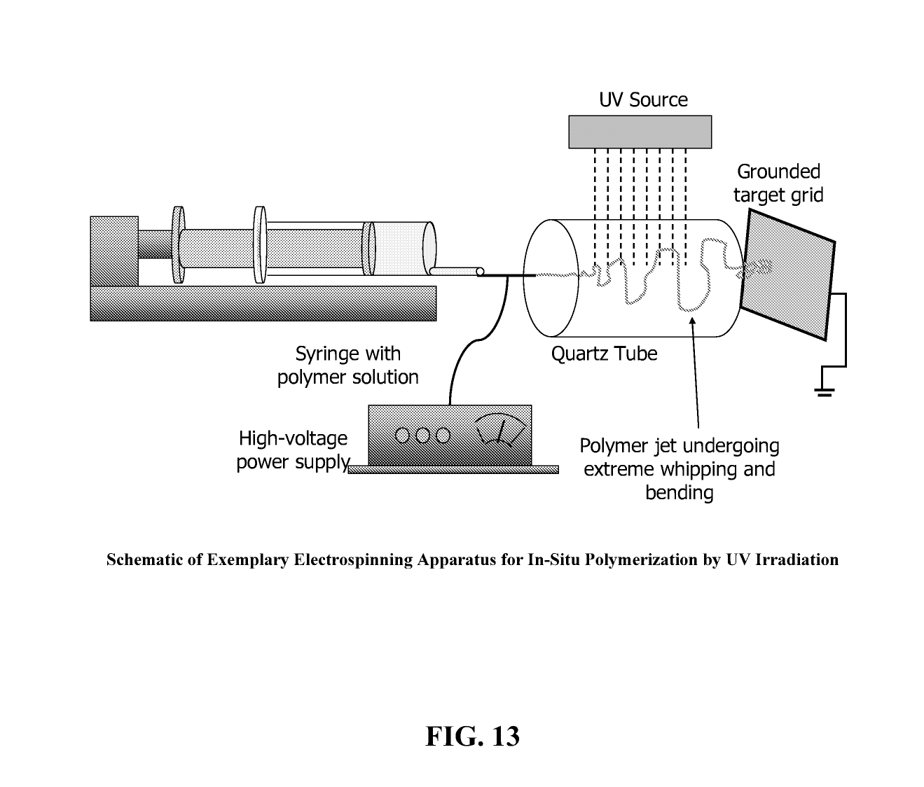

FIG. 13 shows a schematic of exemplary electrospinning apparatus for in-situ polymerization by way of UV irradiation. In-situ crosslinking during electrospinning of polymer fibers has been shown using UV irradiation. Using a methacrylate-functionalized surfactant with a UV-active initiator, or simply using an acetylene- or diene-functionalized surfactant, fibers can be polymerized in situ.

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Other embodiments of the invention will be apparent to those skilled in the art from consideration of the specification and practice of the invention. The description of the invention provided is merely exemplary in nature and, thus, variations that do not depart from the essence of the invention are intended to be within the scope of the invention.

1. A nonwoven membrane comprising amphiphilic fibers having an average fiber diameter of less than about 100 μm.

2. The membrane according to claim 1, wherein said fibers are chosen from anionic surfactants, cationic surfactants, nonionic surfactants, phospholipids, sulfobetaines, lyotropic liquid crystalline molecules, and block copolymers having a number average molecular weight of less than about 10,000.

3. The membrane according to claim 1, wherein said fibers comprise phospholipids.

4. The membrane according to claim 1, wherein said fibers comprise surfactants.

5. Amphiphilic fibers having an average fiber diameter of less than about 100 μm.

6. The amphiphilic fibers according to claim 5, wherein said fibers have an average fiber diameter ranging from about 0.1 μm to about 10 μm.

7. The amphiphilic fibers according to claim 6, wherein said fibers have an average fiber diameter ranging from about 0.5 μm to about 10 μm.

8. The amphiphilic fibers according to claim 7, wherein said fibers have an average fiber diameter ranging from about 1 μm to about 10 μm.

9. The amphiphilic fibers according to claim 8, wherein said fibers have an average fiber diameter ranging from about 1 μm to about 5 μm.

10. The amphiphilic fibers according to claim 6, wherein said fibers have an average fiber diameter ranging from about 100 nm to about 2 μm.

11. The amphiphilic fibers according to claim 10, wherein said fibers have an average fiber diameter ranging from about 100 nm to about 1 μm.

12. The amphiphilic fibers according to claim 11, wherein said fibers have an average fiber diameter ranging from about 100 nm to about 500 nm.

13. The amphiphilic fibers according to claim 5, wherein said fibers are prepared by electrospinning.

14. The electrospun amphiphilic fibers according to claim 13, wherein said fibers comprise phospholipid fibers having an average fiber diameter of less than about 10 μm.

15. A biocompatible device comprising amphiphilic fibers having an average fiber diameter of less than about 10 μm.

16. The biocompatible device according to claim 15, wherein said device comprises said amphiphilic fibers as a coating.

17. A process for preparing amphiphilic fibers or a nonwoven membrane comprising electrospinning a solution comprising at least one amphiphilic molecule chosen from anionic surfactants, cationic surfactants, nonionic surfactants, phospholipids, sulfobetaines, lyotropic liquid crystalline molecules, and block copolymers, wherein said block copolymers have a number average molecular weight of less than about 10,000.

18. The process according to claim 17, wherein said at least one amphiphilic molecule is a phospholipid.

19. The process according to claim 17, wherein said electrospinning comprises delivering said solution at 6 mL/hr in a 15 kV electric field.

20. The process according to claim 17, wherein said amphiphilic fibers have an average fiber diameter of less than about 10 μm.

21. The process according to claim 20, wherein said amphiphilic fibers have an average fiber diameter ranging from about 1 μm to about 10 μm.

22. The process according to claim 17, wherein said solution comprises lecithin or n-hexadecyl trimethyl ammonium bromide (CTAB).

23. The process according to claim 17, wherein said solution comprises spherical or worm-like micelles in an amount above the entanglement concentration.
